(19) United States
(12) Patent Application Publication
(10) Pub. No.: US 2019/0295434 A1
(43) Pub. Date: Sep. 26, 2019

(54) METHOD AND APPARATUS FOR GENERATING ILLUSTRATIONS BY BOTH RIGHT AND LEFT HANDED ARTISTS

(71) Applicant: Tifanja LLC, Tipp City, OH (US)

(72) Inventor: Jaime Rhyne, Tipp City, OH (US)

(73) Assignee: Tifanja LLC, Tipp City, OH (US)

(21) Appl. No.: 16/362,267

(22) Filed: Mar. 22, 2019

Related U.S. Application Data
(60) Provisional application No. 62/646,502, filed on Mar. 22, 2018.

(51) Int. Cl. G09B 11/04; G09B 11/10

(52) U.S. Cl. CPC G09B 11/04; G09B 11/10

(57) ABSTRACT

An art kit guide and related method which is customizable for use with a user's dominant hand.

### CROSS-REFERENCE TO RELATED APPLICATION

This application claims the benefit of U.S. Provisional Application Ser. No. 62/646,502, filed Mar. 22, 2018, the disclosure of which is expressly incorporated by reference herein.

### BACKGROUND AND SUMMARY OF THE DISCLOSURE

The present disclosure relates to art guide kits and, more particularly, to art guide kits customizable for use with a user's dominant hand.

Art guide kits are known. Some art guide kits use grids, stenciling, step-by-step instructions, color-by-number, and other methods to assist a user in creating works of art or to teach a user how to create works of art. It is desired by users to be able to create works of art without accidentally smearing the medium with which the art is created by their hand or hands.

In an illustrative embodiment of the present disclosure, an art guide kit includes a substrate and a design pre-printed on at least one quadrant of the substrate in a way that allows a user to create a mirror image of the design across an axis of the substrate.

According to an illustrative embodiment of the present disclosure, an art guide kit includes a first substrate, and a first design pre-printed on at least one quadrant of the first substrate to the left of a vertical axis thereby allowing a user to create a mirror image of the first design across the vertical axis of the first substrate using a right hand of the user. The art guide kit further includes a second substrate, and a second design pre-printed on at least one quadrant of the second substrate to the right of a vertical axis thereby allowing a user to create a mirror image of the second design across the vertical axis of the second substrate using a left hand of the user.

In another illustrative embodiment of the present disclosure, a method for generating an illustration includes the steps of providing an art guide kit comprising a substrate and a design pre-printed on at least one quadrant of the substrate, providing a medium for creating an image on the substrate, and creating an approximate mirror image of the design to the left of the vertical axis of the substrate.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is an overhead view of an art guide kit for a user with a dominant right hand;

FIG. 2 is an overhead view of an art guide kit for a user with a dominant left hand;

FIG. 3 is a perspective view of an illustrative substrate and mounting of the art guide kit of FIG. 1; and

FIG. 4 is an overhead view of an art guide kit while in use by a user with a dominant right hand.

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

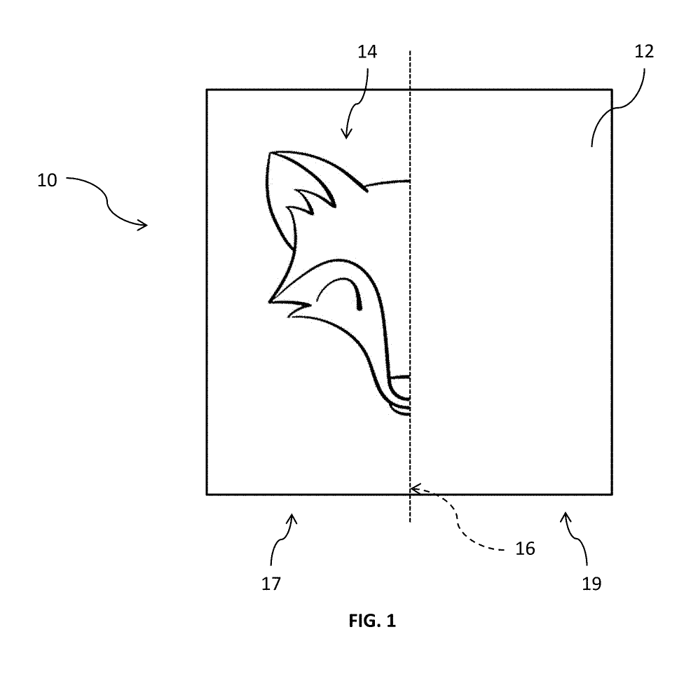

Referring initially to FIG. 1, an illustrative art guide kit 10 of the present disclosure is shown as including a substrate 12 supporting a design 14. Substrate 12 may be comprised of a variety of substrates on which a design 14 may be printed and/or drawn, including, but not limited to, plastic films or foils, release liners, plastic containers, wood, foamboard, parchment, leather, glass, metal, plaster, scratchboard, etc. Substrate 12 may also or alternately be comprised of a number of textiles, including, but not limited to, canvas, various fabrics, cloth, etc. Substrate 12 may also or alternately be comprised of a number of paper products, including, but not limited to, lightweight printing paper, heavyweight paper, coated paper, uncoated paper, paperboard, cardboard, cotton paper, wax paper, card stock, etc.

As shown in FIG. 1, illustrative design 14 may comprise of an animal, such as a fox. However, design 14 is not limited to the design as shown in FIG. 1. For example, design 14 may portray a number of cartoon or realist figures. Design 14 may portray a number of different people, places, or things, including, but not limited to, vehicles, holiday characters, animals, toys, foods, caricatures, cartoon characters, etc. Design 14 may also portray abstract designs or a number of other types of designs, including, but not limited to, surrealist designs, conceptual designs, pop art designs, hyperrealist designs, futurist designs, photorealist designs, and others.

Still referring to FIG. 1, design 14 is illustratively preprinted on substrate 12 in a way that a user having a dominant right hand can use art guide kit 10 to create a work of art without smearing the section of the work that corresponds with the user's non-dominant left hand. For example, in FIG. 1, line 16 illustratively extends along a vertical (y) axis and defines a first side (e.g., first half) 17 and a second side (e.g., second half) 19 of substrate 12. In an illustrative embodiment, first side 17 defines a left side of substrate 12, while second side 19 defines a right side of substrate 12. In alternate embodiments, line 16 may extend along a horizontal (x) axis such that first side 17 defines a top or upper portion of substrate 12, while second side 19 defines a bottom or lower portion of substrate 12. As shown in FIG. 1, design 14 is printed only on the left side of line 16 so that a user having a dominant right hand is required only to complete the half of the work of art that corresponds to the user's dominant hand by drawing a mirror image of design 14 across line 16.

In another illustrative embodiment, art guide kit 10 may include design 14 that corresponds to a quadrant of substrate 12 relative to a horizontal (x) axis and a vertical (y) axis rather than a half of substrate 12 relative to line 16. More particularly, a pair of substantially perpendicular lines 16 defines four quadrants on substrate 12, including an upper left quadrant, a lower left quadrant, an upper right quadrant, and a lower right quadrant. This would encourage the user to create a work of art by drawing the mirror image of design 14 across either the x-axis or the y-axis and complete the process of drawing the mirror image of design 14 across all relevant axes until the drawing is complete and all four quadrants of substrate 12 have been filled.

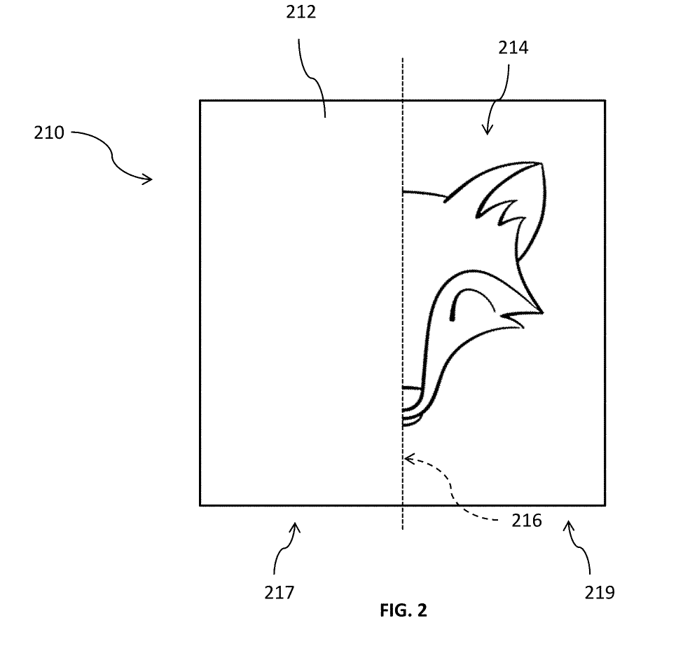

In another illustrative embodiment, as shown in FIG. 2, design 214 is preprinted on substrate 212 in a way that a user having a dominant left hand can use art guide kit 210 to create a work of art without smearing the section of the work that corresponds with the user's non-dominant right hand. For example, in FIG. 2, line 216 extends along a vertical (y) axis and defines a first side (e.g., first half) 217 and a second side (e.g., second half) 219 of substrate 212. In an illustrative embodiment, first side 217 defines a left side of substrate 212, while second side 219 defines a right side of substrate 212. In alternate embodiments, line 216 may extend along a longitudinal (x) axis such that first side 217 defines a top or upper portion of substrate 212, while second side 219 defines a bottom or lower portion of substrate 12. As shown in FIG. 2, design 214 is printed only on the right side of line 216 so that a user having a dominant left hand is required only to complete the half of the work of art that corresponds to the user's dominant hand by drawing a mirror image of design 214 across line 216.

In another illustrative embodiment, art guide kit 210 may include design 214 that corresponds to a quadrant of substrate 212 relative to a horizontal (x) axis and a vertical (y) axis rather than a half of substrate 212 relative to line 216. More particularly, a pair of substantially perpendicular lines 216 defines four quadrants on substrate 212, including an upper left quadrant, a lower left quadrant, an upper right quadrant, and a lower right quadrant. This would encourage the user to create a work of art by drawing the mirror image of design 214 across either the x-axis or the y-axis and complete the process of drawing the mirror image of design 214 across all relevant axes until the drawing is complete and all four quadrants of substrate 212 have been filled. It is possible, and sometimes likely, that the mirror image created by the user is not an exact mirror image, but rather approximates a mirror image of design 214.

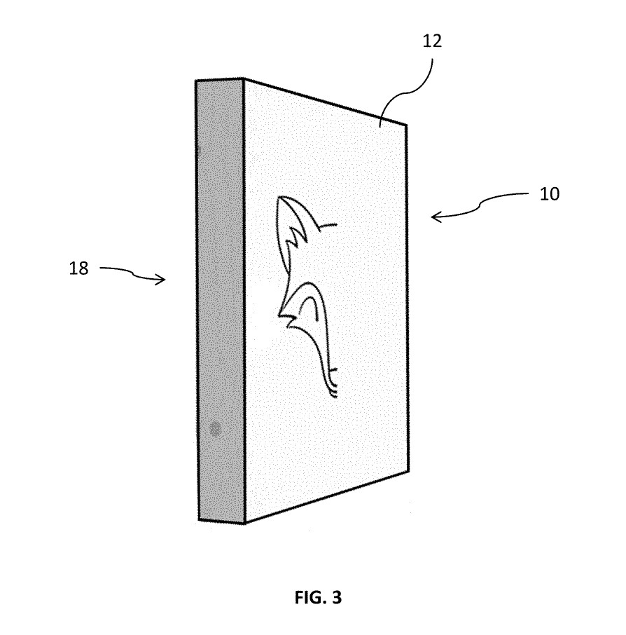

In an illustrative embodiment, as shown in FIG. 3, art guide kit 10 further comprises mounting blocks 18. Mounting blocks 18 form the outline of a polygon, which is hollow underneath at least a portion of substrate 12. Substrate 12 is illustratively stretched across and coupled to mounting blocks 18, making substrate 12 taut for greater ease in completing a work of art. The hollow formed by mounting blocks 18 underneath at least a portion of substrate 12 also provides greater ease for a user to hang art guide kit 10 on a wall, if desired.

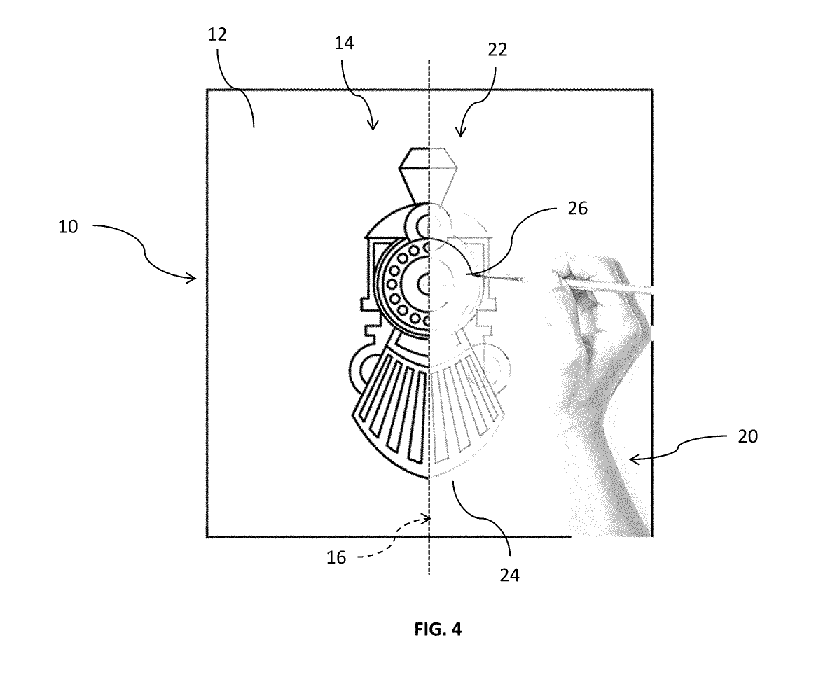

Referring to FIG. 4, an illustrative method of using art guide kit 10 is shown. User 20 creates a mirror image of design 14 across line 16. As shown in FIG. 4, user 20 can first create a sketch 22 of a substantially similar mirror image of design 14 across line 16 using a first medium (e.g., pencil) 24, and then complete the work of art by tracing sketch 22 with a second medium (e.g., paint) 26. In some embodiments, user 20 can complete the work of art by creating a mirror image of design 14 across line 16 using one or more media over more than one attempt. In alternate embodiments, user 20 can complete the work of art by creating a mirror image of design 14 across line 16 using a single medium in a single attempt. User 20 is able to use a variety of media, including, but not limited to, pencil, pen, crayon, etching, paint, wax, ink, graphite, chalk, airbrush, charcoal, watercolor, etc.

Illustratively, the art guide kit 10 includes a first substrate 12 including design 14 supported on the left side of line 16 for a user with a dominant right hand (FIG. 4), and a second substrate 212 including design 214 on the right side of line 216 for a user with a dominant left hand. As noted above, a pair of substantially perpendicular lines (e.g., along horizontal (x) and vertical (y) axes) may define quadrants on substrate 12, including an upper left quadrant, a lower left quadrant, an upper right quadrant, and a lower right quadrant. In other embodiments, more divided areas may be used

An illustrative guide kit may include both substrates 12 and 212 having respective designs 14 and 214. Such a guide kit provides flexibility such that a user having a dominant right hand can use substrate 12 to create a work of art, or a user having a dominant left hand can use substrate 212 to create a work of art. The guide kit may also include at least one medium to create the approximate mirror images on the substrates 12 and 212.

Although the invention has been described in detail with reference to certain preferred embodiments, variations and modifications exist within the spirit and scope of the invention as described and defined in the following claims.

What is claimed is:

1. An art guide kit, comprising:
a first substrate, and a first design pre-printed on at least one quadrant of the first substrate to the left of a vertical axis thereby allowing a user to create a mirror image of the first design across the vertical axis of the first substrate using a right hand of the user; and
a second substrate, and a second design pre-printed on at least one quadrant of the second substrate to the right of a vertical axis thereby allowing a user to create a mirror image of the second design across the vertical axis of the second substrate using a left hand of the user.

2. The art guide kit of claim 1, wherein the design is pre-printed on at least one half of the substrate.

3. The art guide kit of claim 1, wherein the substrate comprises of a canvas.

4. The art guide kit of claim 1, wherein the kit forms a polygon.

5. The art guide kit of claim 1, further comprising mounting blocks coupled to the substrate.

6. The art guide kit of claim 5, wherein the mounting blocks form a hollow under at least a portion of the substrate.

7. The art guide kit of claim 1, wherein either the first design or the second design is an animal.

8. The art guide kit of claim 1, wherein either the first design or the second design is a vehicle.

9. The art guide kit of claim 1, wherein either the first design or the second design is a landscape.

10. A method for generating an illustration, comprising the steps of:
providing an art guide kit comprising a substrate and a design pre-printed on at least one quadrant of the substrate;
providing a medium for creating an image on the substrate; and
creating an approximate mirror image of the design across an axis of the substrate.

11. The method for generating an illustration of claim 10, further comprising the steps of providing a second medium for creating an image on the substrate and copying the approximate mirror image of the design.

12. The method for generating an illustration of claim 10, wherein the medium is paint.

13. The method for generating an illustration of claim 10, wherein the medium is pencil.

14. The method of claim 10, wherein the design is pre-printed on the left side of a vertical axis of the substrate for use by a user with a dominant right hand.

15. The method of claim 10, wherein the design is pre-printed on the right side of a vertical axis of the substrate for use by a user with a dominant left hand.
